(19) United States
(12) Patent Application Publication
(10) Pub. No.: US 2014/0006338 A1
(43) Pub. Date: Jan. 2, 2014

(54) BIG DATA ANALYTICS SYSTEM

(71) Applicant: Applied Materials, Inc., Santa Clara, CA (US)

(72) Inventors: Scott Watson, Plano, TX (US); Jamini Samantaray, San Ramon, CA (US); John Scoville, Phoenix, AZ (US); James Moyne, Canton, MI (US)

(21) Appl. No.: 13/929,615

(22) Filed: Jun. 27, 2013

Related U.S. Application Data
(60) Provisional application No. 61/666,667, filed on Jun. 29, 2012.

(51) Int. Cl. G06F 17/30

(52) U.S. Cl. CPC G06F 17/30563
USPC 707/602

(57) ABSTRACT

A big data analytics system obtains a plurality of manufacturing parameters associated with a manufacturing facility. The big data analytics system identifies first real-time data from a plurality of data sources to store in memory-resident storage based on the plurality of manufacturing parameters. The plurality of data sources are associated with the manufacturing facility. The big data analytics system obtains second real-time data from the plurality of data sources to store in distributed storage based on the plurality of manufacturing parameters.

### RELATED APPLICATIONS

This application is related to and claims the benefit of U.S. Provisional Patent application Ser. No. 61/666,667, filed Jun. 29, 2012, which is hereby incorporated by reference.

### TECHNICAL FIELD

Implementations of the present disclosure relate to an analytics system, and more particularly, to a big data analytics system.

### BACKGROUND

Data collection rates are increasing as more data is collected to support effective operation of systems. Advances in manufacturing facility (factory) automation, tighter process tolerances, improved tool capabilities and the desire to improve yield can lead to additional data to be collected.

Data collection rates may increase in manufacturing facilities due to increasing wafer sizes causing data to be collected at a faster rate, thereby causing a larger amount of data to be collected. Advanced tool platforms may require a growth in the number of sensors that will be required for these advanced technologies. Additionally, as technology nodes shorten, equipment constant identifiers (ECIDs) and collection event identifiers (CEIDs) may increase. Moreover, many manufacturing facilities are decreasing lot sizes (e.g., to improve cycle time), and smaller lot sizes may require additional transactional data to manage the smaller lots sizes.

Some traditional solutions attempt to collect data and monitor the quality of a manufacturing process using statistical process control methodology. Moreover, traditional solutions move most data into data storage in case it may be needed in the future, without processing the data. Other traditional solutions can include relational database management system (RDBMS) technologies. However, these traditional solutions cannot process large sets of data in real-time to support complex data analytics.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” implementation in this disclosure are not necessarily to the same implementation, and such references mean at least one.

FIG. 1 is a block diagram illustrating a big data analytics system utilizing a big data analytics module.

FIG. 2 a block diagram of one implementation of a big data analytics module.

FIG. 3 illustrates an example graphical user interface including data for a graphical schema for a rule used by a big data analytics module, according to various implementations.

FIG. 4 illustrates one implementation of a method for analyzing big data in a manufacturing facility.

FIG. 5 illustrates one implementation of using big data analytics in a manufacturing facility.

FIG. 6 illustrates an example computer system.

### DETAILED DESCRIPTION

Data collected in a manufacturing facility can be used to achieve yield improvement, cycle time and cost reduction desired by the semiconductor manufacturing industry. However, with increasing amount of data collected from a manufacturing facility, it may be difficult to effectively use the data, such as to resolve a problem in the manufacturing facility. The manufacturing facility operations can strive for optimization of processes to improve yields of materials and tools, which can require effective use of the large amount of data generated in real-time and collected, and to discover patterns and data trends through collection and analysis of data. The collected data can be used to predict and resolve issues before the issues occur in the manufacturing facility. Predictive technology can be used to analyze data to detect indicators of tool excursions before the excursions occur, to predict yield excursions to allow in-line resolution, to predict lot arrival times for improved scheduling, to provide productivity improvements, etc.

Storing and processing the increasing amount of data collected in a manufacturing facility can impact on-line transaction processing (OLTP) requirements of factory automation. Moreover, the increasing amount of data needs to be analyzed, which can require an increase in engineering staff. In addition, extreme transaction processing (XTP) data processing may need to be supported by the manufacturing facility to perform prediction-based analysis, decision tree analysis, automated simulations, and on-demand simulations.

To process the large amount of data collected by manufacturing facilities, a big data analytics system can obtain manufacturing parameters associated with a manufacturing facility that define the data that is important and relevant to a user of the manufacturing facility. The big data analytics system can identify real-time manufacturing data that is more relevant by identifying the real-time manufacturing data that meets the manufacturing parameters. The big data analytics system can store the more relevant real-time data in memory-resident storage. The big data analytics system can identify manufacturing real-time data that is less relevant by identifying the real-time manufacturing data that does not meet the manufacturing parameters. The big data analytics system can store the less relevant real-time data in distributed storage. The memory-resident storage can be in memory, and thus quickly accessible. The distributed storage cannot be in memory and is therefore less easily accessible. By storing the more relevant real-time data in memory-resident data storage, the big data analytics system can perform processing of the relevant real-time data efficiently and effectively (on-line transaction processing, extreme transaction processing, etc.). Moreover, by storing the more relevant real-time data in memory-resident data storage and the less relevant real-time data in distributed storage, the big data analytics system can store and process large amounts of data without impacting the processing of the more relevant data and without requiring an increase in engineering staff.

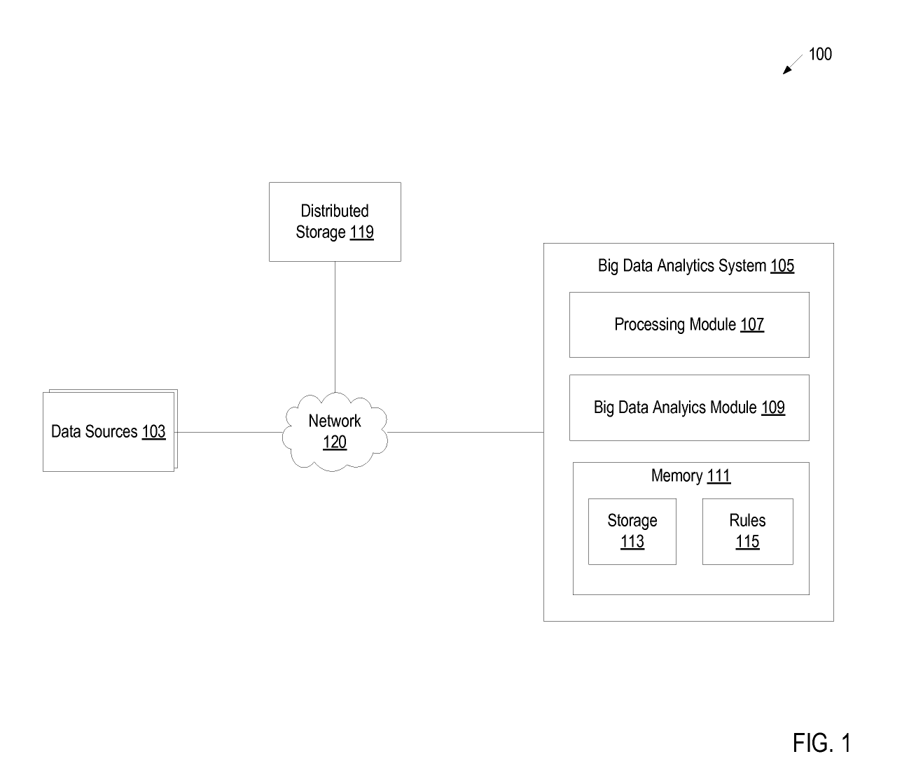

FIG. 1 is a block diagram of a manufacturing facility 100 that implements big data analytics. The manufacturing facility 100 can include for example, and is not limited to, a semiconductor manufacturing facility. For brevity and simplicity, a manufacturing facility 100 can include one or more data sources 103, a big data analytics system 105, and a distributed storage 119 communicating, for example, via a network. 120. The network 120 can be a local area network (LAN), a wireless network, a mobile communications network, a wide area network (WAN), such as the Internet, or similar communication system.

The data sources 103 can be manufacturing data sources. Examples of the data sources 103 can include tools for the manufacture of electronic devices, manufacturing execution system (MES), material handling system (MHS), SEMI equipment communications standard/generic equipment model (SECS/GEM) tools, electronic design automation (EDA) system, etc.

The data sources 103 and the big data analytics system 105 can be individually hosted by any type of computing device including server computers, gateway computers, desktop computers, laptop computers, tablet computer, notebook computer, PDA (personal digital assistant), mobile communications devices, cell phones, smart phones, hand-held computers, or similar computing device. Alternatively, any combination of the data sources 103 and the big data analytics system 105 can be hosted on a single computing device including server computers, gateway computers, desktop computers, laptop computers, mobile communications devices, cell phones, smart phones, hand-held computers, or similar computing device.

Distributed storage 119 can include one or more writable persistent storage devices, such as memories, tapes or disks. Although each of big data analytics system 105 and distributed storage 119 are depicted in FIG. 1 as single, disparate components, these components may be implemented together in a single device or networked in various combinations of multiple different devices that operate together. Examples of devices may include, but are not limited to, servers, mainframe computers, networked computers, process-based devices, and similar type of systems and devices. Distributed storage 119 can be storage that is distributed across multiple data systems, such as a distributed database.

During operation of the manufacturing system 100, the big data analytics system 105 can receive real-time data to be collected from one or more of the data sources 103. As discussed above, the amount of data received in real-time is large and can affect the processing of the data.

Aspects of the present disclosure address the above deficiency of conventional systems. In particular, in one embodiment, the big data analytics system 105 identifies real-time data that can be stored in memory-resident storage and real-time data that can be stored in distributed storage based on rules associated with the manufacturing system 100, such that the processing if data is not affected. In one embodiment, the big data analytics system 105 can include a processing module 107, a big data analytics module 109, and a memory 111.

The big data analytics module 109 can present a user interface to collect one or more rules for the manufacturing system 100. The rules for the manufacturing system 100 can define data that is relevant in the manufacturing system 100. The rules can be defined by a user (e.g., system engineer, process engineer, industrial engineer, system administrator, etc.). The rules can be stored in rules 115.

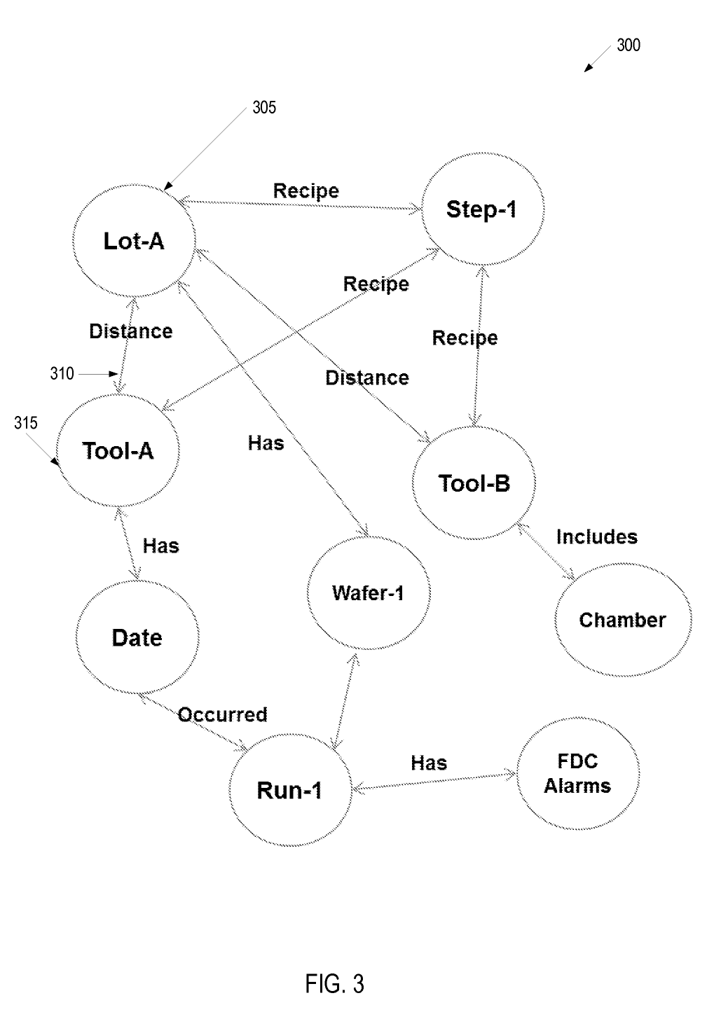

The big data analytics module 109 can receive a real-time data stream from the one or more data sources 103. The real-time data stream includes data to be collected by the big data analytics system 105. The big data analytics module 109 can identify real-time data from the data sources 103 to store in storage 113 in the memory 111, which is resident in the big data analytics system 105. The big data analytics module 109 can identify the real-time data that does not satisfy one or more rules in the rules 115 as real-time data to store in distributed storage 119. The big data analytics module 109 can identify the real-time data that does satisfy one or more rules in the rules 115 as real-time data to store in the storage 113 in memory 111. In some embodiments, the big data analytics module 109 can store a graphical representation of the real-time data that satisfies the one or more rules 115 in storage 113, rather than storing the real-time data itself. The big data analytics module 109 can store data in the storage 113 in memory 111 in a schema suitable for processing by the processing module 107. An example of a data stored in a schema suitable for processing is described below in reference to FIG. 3.

In one embodiment, the big data analytics module 109 applies analytics on the data in the storage 113 in memory 111 and update the data in the storage 113 in memory 111 based on the applied analytics. In an alternate embodiment, the big data analytics module 109 provides the data to a server (not shown) outside of the manufacturing system 100 for analytics application.

The big data analytics module 109 can continuously apply the rules 115 to the real time data stream associated with the data sources 103. As the rules are updated or new rules are added (e.g., by a user), the big data analytics module 109 can apply the updated rules and/or new rules to the data stored in storage 113. Moreover, as the rules are updated or new rules are added, the big data analytics module 109 can apply the rules to the data in distributed storage 119 to determine if data in the distributed storage 119 should be processed and/or analyzed (e.g., if an event is triggered based on the rules, etc.).

Processing module 107 can perform processing of the data in storage 113 in memory 111. For example, processing module 107 can perform processing, such as shared nothing massive parallel processing of the data, map-reduce processing, on-line transaction processing, extreme transaction processing, etc. The processing module 107 can store the results of the processing in storage, such as storage 113, distributed storage 119, etc.

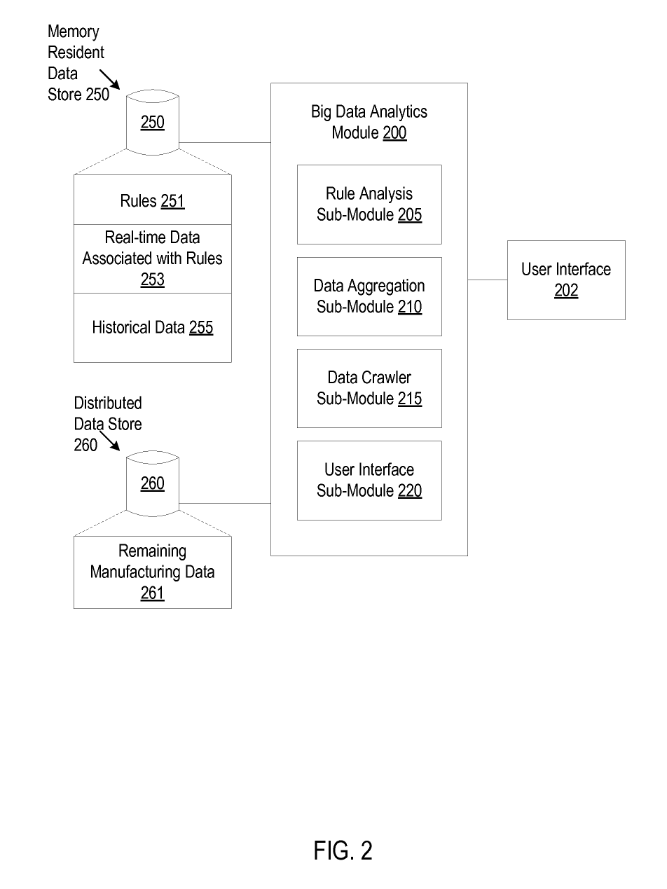

FIG. 2 is a block diagram of one implementation of a big data analytics module 200. In one implementation, the big data analytics module 200 can be the same as the big data analytics module 107 of FIG. 1. The big data analytics module 200 can include a rule analysis sub-module 205, a data aggregation sub-module 210, a data crawler sub-module 215, and a user interface (UI) sub-module 220.

The big data analytics module 200 can be coupled to data stores 250 and 260.

The data store 250 can be a data store that is resident in memory. The data store 250 can include an in-memory non-distributed cache, an in-memory distributed cache, an in-memory graph database, etc. The data store 250 can further include an in-memory database such as an on-line transaction processing refined database, an on-line analytics refined database, etc. In some embodiments, the data store 250 is also a persistent storage, such as an in-memory database that persists data on disk. A persistent storage unit can be a local storage unit or a remote storage unit. Persistent storage units can be a magnetic storage unit, optical storage unit, solid state storage unit, electronic storage unit (main memory) or similar storage unit. Persistent storage units can be a monolithic device or a distributed set of devices. A ‘set’, as used herein, refers to any positive whole number of items. The data store 250 can include rules 251, real-time data associated with rules 253, and historical data 255.

The data store 260 can be a persistent storage unit, such as a distributed database. A persistent storage unit can be a local storage unit or a remote storage unit. Persistent storage units can be a magnetic storage unit, optical storage unit, solid state storage unit, electronic storage unit (main memory) or similar storage unit. Persistent storage units can be a monolithic device or a distributed set of devices. A ‘set’, as used herein, refers to any positive whole number of items.

One or more rules for the manufacturing facility can be defined in the rules 251. The rules 251 can be pre-defined and/or user (e.g., system engineer, process engineer, industrial engineer, system administrator, etc.) defined. The rules 251 can define data collected from the manufacturing facility to identify and resolve common failure modes in the manufacturing facility. In one embodiment, the rules 251 are in equation form. In an alternate embodiment, the rules 251 are in graphical form. The historical data 255 can include all data associated with a particular manufacturing process identified in the rules 251.

The data store 260 can store remaining manufacturing data 261. The remaining manufacturing data 261 can include data from a manufacturing facility that is not associated with any of the rules 251. The remaining manufacturing data 261 can be provided by the tools, systems, automation software, etc. in the manufacturing facility.

The rule analysis module 205 can obtain a rule 251 associated with a manufacturing facility. The user can provide the manufacturing parameters in a graph form, in equation form, etc. The rule analysis sub-module 205 can analyze the rules to determine one or more manufacturing parameters associated with the rules 251.

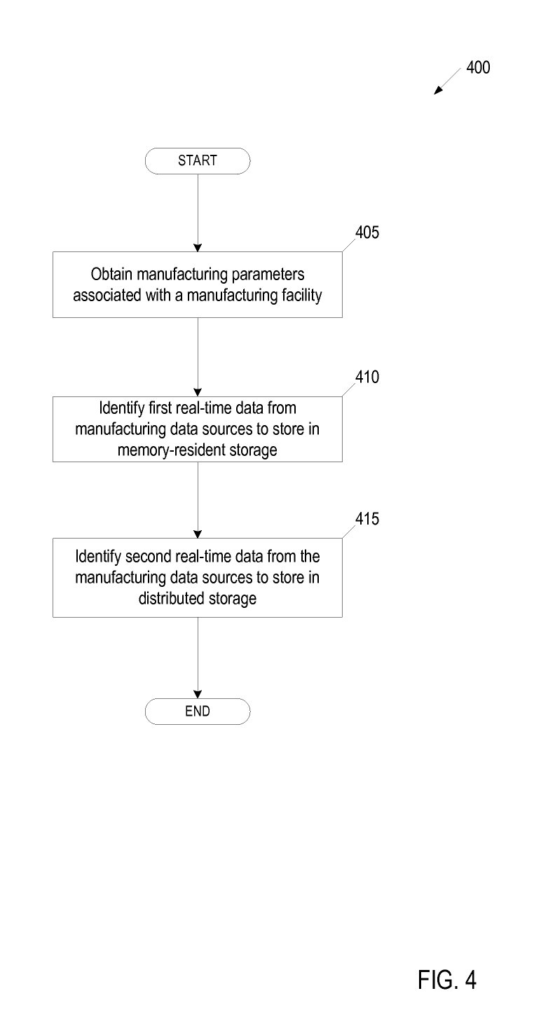

The data aggregation sub-module 210 can identify real-time data from manufacturing data sources (not shown) to store as real-time data associated with rules 253 in memory-resident data store 250 and real-time data from manufacturing data sources to store as remaining manufacturing data 261 in distributed data store 260. The data aggregation sub-module 210 can identify the real-time data from the manufacturing data sources by applying one or more of the rules 251 to a real-time data stream from the manufacturing data sources. The data aggregation sub-module 210 can store the real-time data that satisfies the one or more rules 251 in the real-time data associated with rules 253 in memory resident data store 250. In some embodiments, the data aggregation sub-module 210 can store a graphical representation of the real-time data that satisfies the one or more rules 251 instead of storing the real-time data itself. One method of creating a graphical representation of the real-time data that satisfies the one or more rules 251 is described below in reference to FIG. 4. The data aggregation sub-module 210 can store the real-time data that does not satisfy the one or more rules 251 in the remaining manufacturing data 261 in distributed data store 260.

The data crawler sub-module 215 can apply complex analytics on the real-time data associated with rules 253 and update the real-time data associated with rules 253 based on the applied complex analytics. In one embodiment, the data crawler sub-module 215 applies complex analytics by applying one or more batch processes on the real-time data associated with rules 253. In an alternate embodiment, the data crawler sub-module 215 applies complex analytics by providing the real-time data associated with rules 253 to a business process management (BPM) system (not shown) and receiving the results from the BPM system. The data crawler sub-module 215 can use the historical data 255 to obtain additional data required by an event.

The data crawler sub-module 215 can determine that a manufacturing process associated with a rule in the rules 251 has completed based on data in the real-time data stream from the manufacturing data sources. Upon determining that a manufacturing process associated with a rule in the rules 251 has completed, the data crawler sub-module can store all data associated with a completed manufacturing process to memory-resident storage, such as real-time data associated with rules 253 in the memory resident data store 250.

In some embodiments, the data crawler sub-module 215 obtains additional rules in the rules 251 and determines whether an additional event has occurred based on the additional manufacturing parameters by searching the data store 250 and the data store 260 for data associated with the additional event. If the data crawler sub-module 215 determines that an additional event occurred, the data crawler sub-module 215 can indicate the occurrence of the event to the data aggregation sub-module 210 such that the data aggregation sub-module 210 can store any real-time data associated with the occurrence of the event in the real-time data associated with rules 253.

The data crawler sub-module 215 can use big data analytics to determine whether an event occurred in the manufacturing facility associated with the real-time data stream and obtain data associated with the event. The data crawler sub-module 215 can determine whether an event occurred based on the rules 251 and can obtain data associated with the event from the memory resident data store 250 if the data is stored therein, or from the distributed storage 260 if the data is not stored in the memory resident data store 250.

The user interface (UI) sub-module 220 can present a user interface 202 to obtain rules associated with the manufacturing facility. Upon receiving one or more rules associated with the manufacturing facility via user interface 202, the user-interface sub-module 220 can cause the rules to be stored in data storage, such as rules 251 in data store 250. The user interface 202 can be a graphical user interface (GUI).

FIG. 3 illustrates an example graphical representation 300 of data associated with a manufacturing facility according to various implementations. The graphical representation 300 can be created based on a user-defined rule using data from a manufacturing facility. By storing data from a manufacturing facility using the graphical representation, the data from the manufacturing facility can be processed more efficiently than if the data is stored in an alternative form. The graphical representation 300 can include graph nodes and graph transitions. The graph nodes can be data associated with the variables required by the rule and the graph transitions can be data associated with the conditions required by the rule. The big data analytics module can analyze big data to identify real-time data that meets the variables and conditions required by a rule and create the graphical representation 300 based on the identified real-time data. For example, graphical representation 300 can be associated with a user-defined rule that requires node 305 “Lot-A” to be within a condition 310 “distance” of node 315 “Tool A” in order for the data in the manufacturing facility to be collected. In this example, as real-time data is collected, the big data analytics module can analyze the real-time data to determine if node 305 “Lot-A” is within a node 310 “distance” of node 315 “Tool-A”. If node 305 “Lot-A” is within a condition 310 “distance” of node 315 “Tool-A,” data in the manufacturing facility that is associated with “Tool-A” and “Lot-A” may be identified by the big data analytics module and the graphical representation 300 can be created based on the identified data and the rule. For example, node 305 “Lot-A” can include the data associated with “Lot-A” when “Lot-A” is within condition 310 “distance” of node 315 “Tool-A”. The big data analytics module can create the graphical representation 300 based on the rule and the collected data. One implementation for analyzing big data and creating a graphical representation based on the analyzed big data is described in greater detail below in conjunction with FIG. 4.

FIG. 4 is a flow diagram of an implementation of a method 400 for analyzing big data. Method 400 can be performed by processing logic that can comprise hardware (e.g., circuitry, dedicated logic, programmable logic, microcode, etc.), software (e.g., instructions run on a processing device), or a combination thereof. In one implementation, method 400 is performed by the big data analytics module 107 in big data analysis system 105 of FIG. 1.

At block 405, processing logic obtains manufacturing parameters associated with a manufacturing facility. The manufacturing parameters associated with the manufacturing facility can be based on one or more rules, analytics, etc. In one embodiment, the manufacturing parameters are defined by a user. For example, the manufacturing parameters are defined by a user and are included in a rule, such as “Lot A within a distance X of Tool A.” In one embodiment, processing logic obtains the manufacturing parameters by receiving the manufacturing parameters from a user via a user interface. The user can provide the manufacturing parameters in a graph form, in equation form, etc. In an alternate embodiment, processing logic obtains the manufacturing parameters from a memory, etc. In an alternate embodiment, processing logic obtains the manufacturing parameters by requesting the manufacturing parameters from a user, from a memory, from a data store that is coupled to the processing logic, etc.

At block 410, processing logic identifies first real-time data from manufacturing data sources to store in memory-resident storage. The manufacturing data sources can include manufacturing tools, manufacturing execution system (MES) automation software, material handling system (MHS) automation software, SEMI equipment communications standard/generic equipment model (SECS/GEM) tools, electronic design automation (EDA) data, etc. In one embodiment, processing logic receives a real-time data stream from the manufacturing data sources that includes events and data occurring in the manufacturing data sources. In one embodiment, an equipment adaptor collects all the events and data from the manufacturing tools and sends the events and data as the real-time data stream.

Processing logic can identify the first real-time data from the manufacturing data sources by applying one or more of the manufacturing parameters to the real-time data stream from the manufacturing data sources, determining whether data in the real-time data stream satisfies the manufacturing parameters, and identify the portion of the real-time data stream that matches the manufacturing parameters as the first real-time data. By satisfying the manufacturing parameters, the first real-time data is data that may be important or relevant to a user and may be needed to identify and resolve common failure modes in the manufacturing facility. Processing logic can apply one or more of the manufacturing parameters to the real-time data stream and compare the data in the real-time data stream to determine if the data in the real-time data stream matches the manufacturing parameters. The data that matching the manufacturing parameters is identified as the first real-time data. For example, if the manufacturing parameters include Lot A and Tool A, and a portion of the real-time data stream includes data that Lot A is currently in Tool A, processing logic will determine that the portion of the real-time data stream including Lot A and Tool A matches the manufacturing parameters and identify this data as the first real-time data.

Upon identifying the first real-time data, processing logic stores the first real-time data or a graphical representation of the first real-time data in memory-resident storage, also referred to herein as operational storage. Data in the memory-resident storage can be processed and used for extreme transaction processing. In one embodiment, the memory-resident storage is a memory cache. In an alternate embodiment, the memory-resident storage is an in-memory database (e.g. graph database, etc.). In another alternate embodiment, the memory-resident storage includes an in-memory cache and one or more in-memory databases. In one such embodiment, processing logic stores the first real-time data or the graphical representation of the first real-time data to the memory cache and the memory cache can cause the first real-time data or graphical representation of the first real-time data to be written to one or more of the in-memory databases (e.g., when the data is evicted from the memory cache, during a write-through operation, etc.). In an alternate such embodiment, processing logic stores the first real-time data or the graphical representation of the first real-time data to the memory cache and the one or more in-memory databases simultaneously. The memory-resident storage can be accessed quickly by the manufacturing facility.

Prior to storing a graphical representation of the first real-time data, processing logic creates the graphical representation (e.g., graph object) of the first real-time data. In this embodiment, processing logic can store the graphical representation of the first real-time data in the memory-resident storage and store the first real-time data in distributed storage, such as one or more distributed databases accessible to the manufacturing facility. The graphical representation of the first real-time data can be created based on the manufacturing parameters. The graphical representation can be suitable for shared-nothing massive parallel processing of data, map-reduce processing of data, etc. In one embodiment, the graphical representation is a tree representation of the data that includes nodes and transition branches. Processing logic can create the graphical representation of the first real-time data by creating a node in the graphical representation for each manufacturing parameter that is a variable, creating a transition branch in the graphical representation for each manufacturing parameter that is a condition, and connecting the nodes and branches based on the relationship between the manufacturing parameters. For example, if the manufacturing parameters are based on a rule that requires data collection when Lot A is within a predefined distance of Tool A, the manufacturing parameters can include Lot A, the predefined distance, and Tool A. In this example, Lot A and Tool A are manufacturing parameters that are used by rules and “within a predefined distance” is a manufacturing parameter that is a condition. Therefore, in this example, a graphical representation of the manufacturing parameters defined by the rule will include a node for Lot A (reference 305 in FIG. 3) that has a branch transition (reference 310 in FIG. 3) for the condition “within a predefined distance” that leads to a node for Tool A (reference 315 in FIG. 3).

In one embodiment, upon identifying the first real-time data, processing logic can apply complex analytics on the first real-time data (e.g., using batch processes, etc.) and update the memory-resident storage with the analyzed first real-time data. In this embodiment, processing logic can further provide the analyzed first real-time data to a business process management (BPM) system (e.g., server). The BPM system can process the analyzed first real-time data. Processing logic can receive the results of the processing of the first real-time data from the BPM system and store the processed data in the memory-resident storage.

In one embodiment, if the first real-time data indicates that the manufacturing facility has completed a process (e.g., a wafer lot in the manufacturing facility has completed production, etc.), processing logic can store all the data associated with the process to memory-resident storage. Processing logic can determine that the first real-time data indicates that the manufacturing facility has completed a process based on an event condition action (ECA) being satisfied. For example, processing logic creates an event to trigger or be satisfied when the process has completed.

In one embodiment, processing logic can obtain additional manufacturing parameters and determine whether an additional event has occurred based on the additional manufacturing parameters. For example, the additional manufacturing parameters are included in an additional user-defined rule, in a prediction rule, an analytics rule, etc. Upon obtaining additional manufacturing parameters, processing logic can determine whether the additional event occurred by searching the memory resident storage for the additional manufacturing parameters. If the memory-resident storage includes the additional manufacturing parameters, processing logic can determine whether the additional manufacturing parameters are satisfied based on the search. If the memory-resident storage includes more than one level of storage (e.g., a first level of storage is a memory cache, a second level of storage is an in-memory database, etc.), processing logic can search the first level of storage first, the second level of storage if the additional manufacturing parameters are not in the first level of storage, etc. If the memory-resident storage does not include the additional manufacturing parameters, processing logic can search the distributed storage for the additional manufacturing parameters. For example, if the additional manufacturing parameters are for a rule that requires that Lot A has a recipe with Step 1, processing logic can search the memory-resident storage for data that includes Lot A and a recipe for Lot A with Step 1. In this example, if processing logic does not find the data including Lot A and a recipe for Lot A with Step 1, processing logic can search the distributed storage for data that includes Lot A and a recipe for Lot A with Step 1.

At block 415, processing logic identifies second real-time data from the manufacturing data sources to store in distributed storage. Processing logic can identify the second real-time data from the manufacturing data sources as the data in the real-time data stream that did not satisfy the manufacturing parameters. Because the second real-time data does not satisfy the manufacturing parameters, the second real-time data is data that may not be important or relevant to a user and may not be needed to identify and resolve common failure modes in the manufacturing facility. However, the data can still be collected and stored for later use and/or processing. For example, if the manufacturing parameters include Lot A and Tool A, and a portion of the real-time data stream includes data that Lot A is currently in Tool B, processing logic will determine that the portion of the real-time data stream that includes data that Lot A is currently in Tool B does not satisfy the manufacturing parameters and identify this data as the second real-time data.

Upon identifying the second real-time data, processing logic can store the second real-time data in distributed storage, also referred to herein as referential storage. Data in the distributed storage can be stored as historical data and may or may not be used or processed by the manufacturing facility. The distributed storage can include one or more distributed databases or other distributed storage to store a large amount of data.

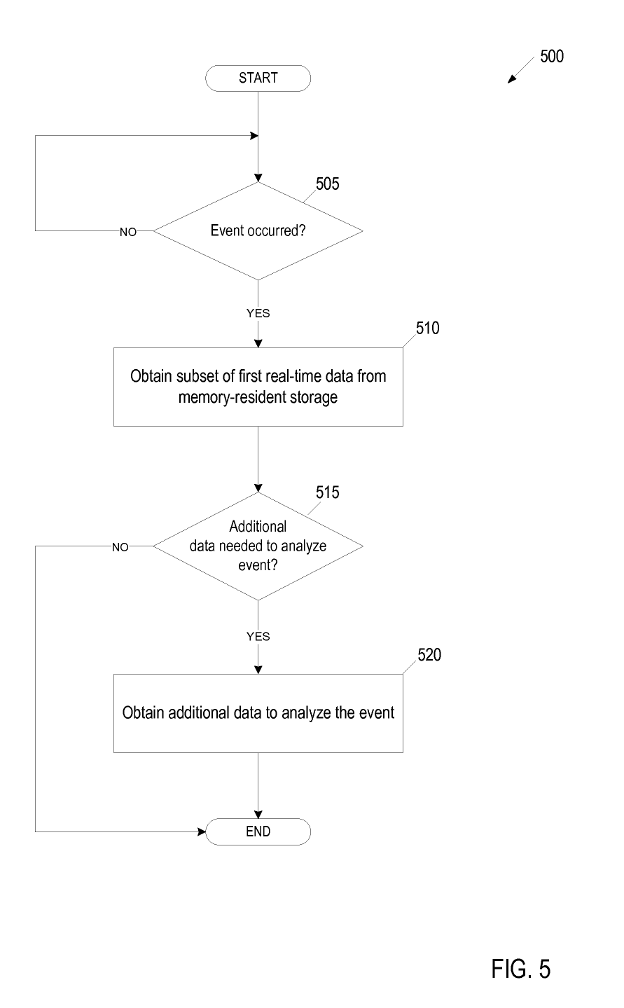

FIG. 5 is a flow diagram of an implementation of a method 500 for using big data analytics. Method 500 can be performed by processing logic that can comprise hardware (e.g., circuitry, dedicated logic, programmable logic, microcode, etc.), software (e.g., instructions run on a processing device), or a combination thereof. In one implementation, method 500 is performed by the big data analytics module 107 in big data analysis system 105 of FIG. 1.

At block 505, processing logic determines whether an event occurred in a manufacturing facility. The event can be based on a rule including one or more conditions. If each of the conditions in the rule occur a in the manufacturing facility, the rule is satisfied, meaning that the event has occurred in the manufacturing facility. The event can be a failure, a lot moving into a specific tool, a lot completing a process, etc. Processing logic can determine whether an event occurred by determining if each of the conditions defined in the rule have occurred in or been satisfied by the manufacturing facility. If each condition defined by the rule have occurred or been satisfied, processing logic can determine that the event has occurred. For example, an event is based on a failure mode defined by a rule that requires conditions X, Y, and Z to occur in the manufacturing facility. In this example, if conditions X, Y, and Z occur in the manufacturing facility, the rule is satisfied and the event is determined to have occurred in the manufacturing facility. In this example, if processing logic determines that the rule is not satisfied (e.g., one or more of conditions X, Y, and Z have not been satisfied), processing logic will determine that the event has not occurred. If processing logic determines that the rule is not satisfied and therefore the event associated with the rule has not occurred, the method 500 continues to wait for the event to occur. If processing logic determines that the rule is satisfied and therefore the event has occurred, the method 500 proceeds to block 510.

At block 510, processing logic obtains a subset of the first real-time data from memory-resident storage. The subset of the first real-time data can include data from the first real-time data that is associated with the conditions that caused the event to occur. In some embodiments, the subset of the first real-time data is a graphical representation of a portion of the first real-time data. In some embodiments, the subset of the first real-time data includes results from one or more analyses of the first real-time data, results from processing of the first real-time data, etc. For example, the first real-time data can include graphical representations of data associated with conditions A, B, C, X, Y, and Z and the event occurred because conditions X, Y, and Z were satisfied. In this example, processing logic obtains the graphical representation of data associated with conditions X, Y, and Z as the subset of the first real-time data. Processing logic can obtain the subset of the first real-time data from memory-resident storage by accessing the memory-resident storage, requesting the data from the memory-resident storage, etc.

At block 515, processing logic determines whether additional data is needed to analyze the event. In one embodiment, processing logic determines whether additional data is needed by determining if historical data is needed for the event. Processing logic can determine if historical data is needed for the event by analyzing a rule associated with the event and determining if additional data is needed based on the rule. For example, an event is triggered because conditions X, Y, and Z were met for Lot A, but the rule associated with the event also requires information on a state of the manufacturing facility when Lot A started the manufacturing process one week ago. In this example, processing logic will determine that the historical information on the state of the manufacturing facility from one week ago is required. In one embodiment, processing logic determines whether additional data is needed by determining if data causing the event to occur is not in a first level of the memory-resident storage. The first level of the memory-resident storage can be an in-memory cache. For example, if the event occurs because conditions X, Y, and Z were met, but data associated with condition Y is not in the in-memory cache, processing logic determines that additional data is needed to analyze the event. In one embodiment, processing logic determines whether additional data is needed by determining if data causing the event to occur is not in the memory-resident storage. Upon determining that no additional data is needed to analyze the event, the method 500 ends. Upon determining that additional data is needed to analyze the event, the method 500 proceeds to block 520.

At block 520, processing logic obtains the additional data to analyze the event. If processing logic determined that additional data is needed because historical data is needed for the event, processing logic can obtain the historical data for the event from memory-resident storage. In some embodiments, the historical data is combined with real-time data obtained from memory-resident storage. If processing logic determined that additional data is needed because the additional data is not in a first level of the memory-resident storage, processing logic can obtain the additional data from a second level of the memory-resident storage, such as an in-memory graph database, an in-memory distributed database, etc. If processing logic determined that additional data is needed because data causing the event to occur is not in the memory-resident storage, processing logic can obtain the additional data from distributed or referential storage, such as a distributed database accessible to the manufacturing facility.

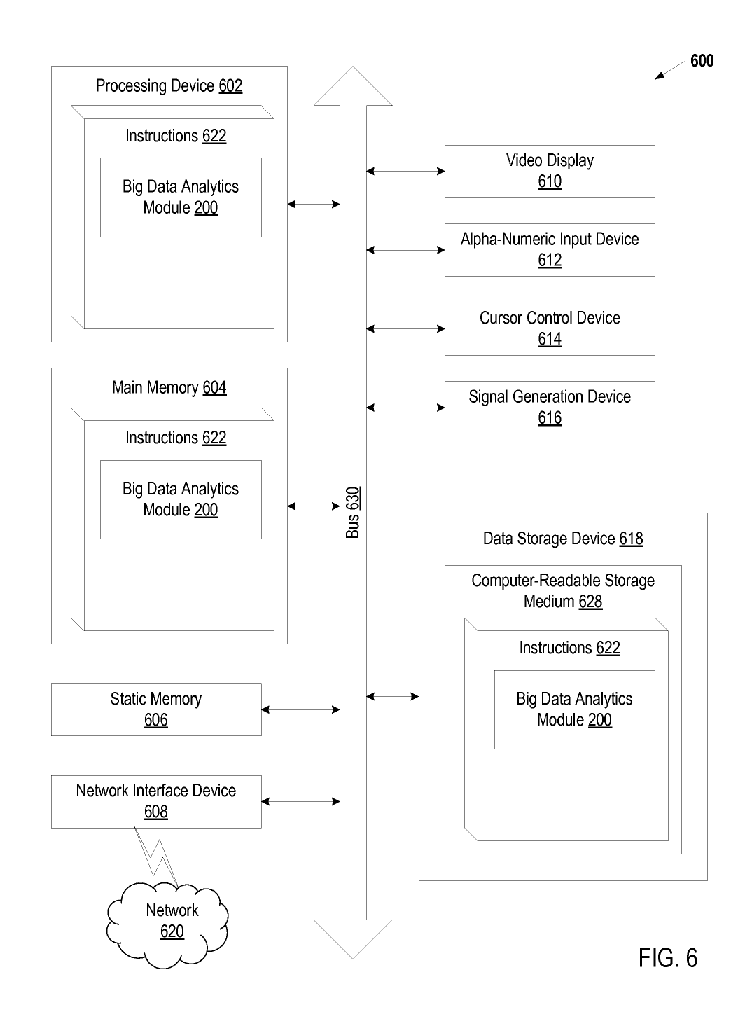

FIG. 6 is a block diagram illustrating an example computing device 600. In one implementation, the computing device corresponds to a computing device hosting an big data analytics module 109 of FIG. 1. The computing device 600 includes a set of instructions for causing the machine to perform any one or more of the methodologies discussed herein. In alternative implementations, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer device 600 includes a processing system (processing device) 602, a main memory 604 (e.g., read-only memory (ROM), flash memory, dynamic random access memory (DRAM) such as synchronous DRAM (SDRAM), etc.), a static memory 606 (e.g., flash memory, static random access memory (SRAM), etc.), and a data storage device 618, which communicate with each other via a bus 608.

Processing device 602 represents one or more general-purpose processing devices such as a microprocessor, central processing unit, or the like. More particularly, the processing device 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also be one or more special-purpose processing devices such as an application specific integrated circuit (ASIC), a field programmable gate array (FPGA), a digital signal processor (DSP), network processor, or the like. The processing device 602 is configured to execute the big data analytics module 200 for performing the operations and steps discussed herein.

The computing device 600 may further include a network interface device 608. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 616 (e.g., a speaker).

The data storage device 618 may include a computer-readable storage medium 628 on which is stored one or more sets of instructions (instructions of big data analytics module 200) embodying any one or more of the methodologies or functions described herein. The big data analytics module 200 may also reside, completely or at least partially, within the main memory 604 and/or within the processing device 602 during execution thereof by the computing device 600, the main memory 604 and the processing device 602 also constituting computer-readable media. The big data analytics module 200 may further be transmitted or received over a network 620 via the network interface device 608.

While the computer-readable storage medium 628 is shown in an example implementation to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that implementations of the disclosure may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “adding,” “providing,” or the like, refer to the actions and processes of a computing device, or similar electronic computing device, that manipulates and transforms data represented as physical (e.g., electronic) quantities within the computer system's registers and memories into other data similarly represented as physical quantities within the computer system memories or registers or other such information storage devices.

Implementations of the disclosure also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
obtaining a plurality of manufacturing parameters associated with a manufacturing facility;
identifying, by a computing system comprising a processing device, first real-time data from a plurality of data sources to store in memory-resident storage based on the plurality of manufacturing parameters, wherein the plurality of data sources are associated with the manufacturing facility; and
identifying, by the computing system, second real-time data from the plurality of data sources to store in distributed storage based on the plurality of manufacturing parameters.

2. The method of claim 1, wherein the plurality of manufacturing parameters are associated with an event, and further comprising:
obtaining a subset of the first real-time data from the memory-resident storage upon the occurrence of the event;
determining whether additional data is needed to analyze the event; and
obtaining the additional data upon determining that the additional data is needed to analyze the event, wherein the additional data is obtained from the memory-resident storage if the additional data is stored in the memory-resident storage, and wherein the additional data is obtained from the distributed storage if the additional data is not stored in the memory-resident storage.

3. The method of claim 1, further comprising:
creating a graphical representation for the first real-time data based on the plurality of manufacturing parameters; and
storing the graphical representation for the first real-time data in the memory-resident storage.

4. The method of claim 1, wherein the memory-resident storage comprises an in-memory database.

5. The method of claim 1, wherein the distributed storage comprises a plurality of distributed databases.

6. The method of claim 1, wherein identifying the first real-time data to store to memory-resident storage comprises:
applying one or more of the plurality of manufacturing parameters to a real-time data stream from at least one of the plurality of data sources;
determining whether a portion of the real-time data stream matches the one or more of the plurality of manufacturing parameters; and
selecting the portion of the real-time data stream as the first real-time data upon determining that the portion of the real-time data stream matches the one or more of the plurality of manufacturing parameters.

7. The method of claim 1, further comprising:
determining whether an additional event has occurred based on a search of the memory-resident storage for a plurality of additional manufacturing parameters associated with the additional event; and
upon determining that the additional event has not occurred based on the search of the memory-resident storage, determining whether the additional event has occurred based on a search of the distributed storage for the plurality of additional manufacturing parameters associated with the additional event.

8. A non-transitory computer-readable storage medium having instructions that, when executed by a processing device, cause the processing device to perform operations comprising:
obtaining a plurality of manufacturing parameters associated with a manufacturing facility;
identifying, by the processing device, first real-time data from a plurality of data sources to store in memory-resident storage based on the plurality of manufacturing parameters, wherein the plurality of data sources are associated with the manufacturing facility; and
identifying, by the processing device, second real-time data from the plurality of data sources to store in distributed storage based on the plurality of manufacturing parameters.

9. The non-transitory computer-readable storage medium of claim 8, wherein the plurality of manufacturing parameters are associated with an event, and wherein the processing device is to perform operations further comprising:
obtaining a subset of the first real-time data from the memory-resident storage upon the occurrence of the event;
determining whether additional data is needed to analyze the event; and
obtaining the additional data upon determining that the additional data is needed to analyze the event, wherein the additional data is obtained from the memory-resident storage if the additional data is stored in the memory-resident storage, and wherein the additional data is obtained from the distributed storage if the additional data is not stored in the memory-resident storage.

10. The non-transitory computer-readable storage medium of claim 8, wherein the processing device is to perform operations further comprising:
creating a graphical representation for the first real-time data based on the plurality of manufacturing parameters; and
storing the graphical representation for the first real-time data in the memory-resident storage.

11. The non-transitory computer-readable storage medium of claim 8, wherein the memory-resident storage comprises an in-memory database.

12. The non-transitory computer-readable storage medium of claim 8, wherein to identify the first real-time data to store to memory-resident storage, the processing device is to perform operations comprising:
applying one or more of the plurality of manufacturing parameters to a real-time data stream from at least one of the plurality of data sources;
determining whether a portion of the real-time data stream matches the one or more of the plurality of manufacturing parameters; and
selecting the portion of the real-time data stream as the first real-time data upon determining that the portion of the real-time data stream matches the one or more of the plurality of manufacturing parameters.

13. The non-transitory computer-readable storage medium of claim 8, wherein the processing device is to perform operations further comprising:
determining whether an additional event has occurred based on a search of the memory-resident storage for a plurality of additional manufacturing parameters associated with the additional event; and
upon determining that the additional event has not occurred based on the search of the memory-resident storage, determining whether the additional event has occurred based on a search of the distributed storage for the plurality of additional manufacturing parameters associated with the additional event.

14. A system comprising:
a memory; and
a processing device coupled to the memory, wherein the processing device is to:
obtain a plurality of manufacturing parameters associated with a manufacturing facility;
identify first real-time data from a plurality of data sources to store in memory-resident storage based on the plurality of manufacturing parameters, wherein the plurality of data sources are associated with the manufacturing facility; and
identify second real-time data from the plurality of data sources to store in distributed storage based on the plurality of manufacturing parameters.

15. The system of claim 14, wherein the plurality of manufacturing parameters are associated with an event, and wherein the processing device is further to:
obtain a subset of the first real-time data from the memory-resident storage upon the occurrence of the event;
determine whether additional data is needed to analyze the event; and
obtain the additional data upon determining that the additional data is needed to analyze the event, wherein the additional data is obtained from the memory-resident storage if the additional data is stored in the memory-resident storage, and wherein the additional data is obtained from the distributed storage if the additional data is not stored in the memory-resident storage.

16. The system of claim 14, wherein the processing device is further to:
create a graphical representation for the first real-time data based on the plurality of manufacturing parameters; and
store the graphical representation for the first real-time data in the memory-resident storage.

17. The system of claim 14, wherein the memory comprises the memory-resident storage, and wherein the memory-resident storage comprises an in-memory database.

18. The system of claim 14, wherein the distributed storage comprises a plurality of distributed databases.

19. The system of claim 14, wherein to identify the first real-time data to store to memory-resident storage, the processing device is to:
apply one or more of the plurality of manufacturing parameters to a real-time data stream from at least one of the plurality of data sources;
determine whether a portion of the real-time data stream matches the one or more of the plurality of manufacturing parameters; and
select the portion of the real-time data stream as the first real-time data upon determining that the portion of the real-time data stream matches the one or more of the plurality of manufacturing parameters.

20. The system of claim 14, wherein the processing device is further to:
determine whether an additional event has occurred based on a search of the memory-resident storage for a plurality of additional manufacturing parameters associated with the additional event; and
upon determining that the additional event has not occurred based on the search of the memory-resident storage, determine whether the additional event has occurred based on a search of the distributed storage for the plurality of additional manufacturing parameters associated with the additional event.
